(19) United States
(12) Patent Application Publication
(10) Pub. No.: US 2025/0224603 A1
(43) Pub. Date: Jul. 10, 2025

(54) VIDEO RATE SPONTANEOUS RAMAN IMAGING AND METHOD FOR USING

(71) Applicant: Andreas Vasdekis, Pullman, WA (US)

(72) Inventors: Andreas Vasdekis, Pullman, WA (US); Demetrios Christodoulides, Los Angeles, CA (US); Lochlann Dunn, Tuscon, AZ (US); Haokun Luo, Los Angeles, CA (US)

(73) Assignees: Andreas Vasdekis, Pullman, WA (US); Demetri Christodoulides, Los Angeles, CA (US); Lochlann Dunn, Tuscon, AZ (US); Haokun Luo, Los Angeles, CA (US)

(21) Appl. No.: 18/408,198

(22) Filed: Jan. 9, 2024

(51) Int. Cl. G02B 21/00; G01N 21/64; G01N 21/65; G02B 21/36; H04N 23/95

(52) U.S. Cl. CPC G02B 21/0032; G01N 21/6458; G01N 21/65; G02B 21/361; H04N 23/95

(57) ABSTRACT

The presented embodiments relate to an advanced imaging method that integrates light-sheet Raman microscopy with photon-sparse imaging technology. This combination allows for the effective identification of targets in low-light conditions, even when light levels are below one photon per pixel. The method utilizes an accelerating Airy-beam light-sheet, which significantly expands the imaging area—by more than tenfold-compared to traditional approaches. This enhancement, in combination with single, or sparse photon detection facilitates Raman imaging at speeds comparable to video rates. Additionally, the technique incorporates photon super-localization, which boosts magnification capabilities without compromising the field of view or image resolution. An exemplary model of this integrated imaging system has been successfully applied to live-cell imaging, revealing improved photostability and providing insights into the impact of cellular noise on metabolic processes.

### CROSS REFERENCE TO RELATED APPLICATION

The present application claims the benefit of the earlier filing date of U.S. provisional application No. 63/480,088, filed on Jan. 16, 2023, the entire contents of which are incorporated herein by reference.

### ACKNOWLEDGMENT OF GOVERNMENT SUPPORT

This invention was made with Government support under Prime Contract No./Contract No. DE-SC0022282 awarded by the United States Department of Energy. The Government has certain rights in this invention

### FIELD

The present disclosure concerns an imaging system that comprises, for example, of light-sheet microscopy, the use of beams to generate the light-sheets that can overcome spatial broadening, detection of sparse photons, and imaging applications thereof, including for biotechnology, biology, physics, and chemistry applications.

### BACKGROUND

The widespread role of metabolism is by now well understood in all aspects of life sciences, including areas such as environmental ecology, bioeconomy and synthetic biology, as well as animal, plan, and human health. Understanding, however, the spatiotemporal dynamics of metabolic reactions and how these dynamics vary within and between cells (clonal or not) with improved precision remains an important biotechnology challenge. This challenge persists to-date due to the absence of related technologies, which occurs primarily for two reasons.

First, methods that do not require light/optics for acquiring metabolic information and can decipher metabolic dynamics, such as positron emission tomography and magnetic resonance spectroscopy, are limited to spatial resolution levels of a few mm's. Similar non optical methods that enable adequate (i.e., subcellular) resolution, such as nanoscale secondary ion mass spectrometry (NanoSIMS), typically require cell fixation and high vacuum equipment, thus, limiting the acquisition of dynamic information and cost-effective analyses.

Second, methods that rely on light/optics for acquiring metabolic information from a cell or an organism lack specificity, as for example enabled by fluorophores that are specific to specific metabolites. As such, light/optical methods suffer from a distinct tradeoff between irradiance requirements (i.e., the amount of light required to acquire key information) and imaging rates (i.e., the amount of time required to acquire key information).

For example, emerging mid-infrared optoacoustics require low powers, but also yield low imaging rates (0.1 Hz) [Pleitez, M. A., et al. Label-free metabolic imaging by mid-infrared optoacoustic microscopy in living cells. Nature Biotechnology, 2020. 38: p. 293-296]. To a similar end, spontaneous Raman imaging [Okada, M., et al. Label-free Raman observation of cytochrome c dynamics during apoptosis. Proceedings of the National Academy of Sciences, 2012. 109: p. 28-32] also requires relatively low powers; however, the underlying ultralow Raman scattering cross sections yield long integration times and less than 0.01 Hz imaging rates.

Coherent Raman imaging methods, such as Anti-Stokes Raman Scattering (CARS) [Evans, C. L., et al. Chemical imaging of tissue in vivo with video-rate coherent anti-Stokes Raman scattering microscopy. Proceedings of the National Academy of Sciences, 2005. 102: p. 16807] and Stimulated Raman Scattering (SRS) [Saar, B. G., et al. Video-Rate Molecular Imaging in Vivo with Stimulated Raman Scattering. Science, 2010. 330: p. 1368] have significantly increased these imaging rates up to ˜30 Hz; however, these coherent Raman methods require irradiance levels that greatly exceed phototoxicity and photodamage thresholds, as recently established in various research papers [Phototoxicity induced in living Hela cells by focused femtosecond laser pulses: a data-driven approach. Biomed. Opt. Express, 2021. 12: p. 7886].

Importantly, the abovementioned technological limitations go beyond metabolic analyses of living cells and organisms. The same limitations pertain to chemical analyses of non-living matter, including but not limited to polymers, fixed cells and organisms, crystals, interfaces, and emulsions that can portray rapid chemical dynamics (requiring greater temporal resolution than 0.01 Hz) and are prone to photodamage.

### SUMMARY

One disclosed embodiment pertains to an imaging apparatus that comprises of a Raman imaging instrument or system, a light-sheet imaging system, and a detector for viewing, generating, and/or capturing an image of single or sparse photons. This apparatus can be used to image a target in a single wavelength or in multiple wavelengths via hyperspectral means. Further, this imaging system exhibits rapid Raman image acquisition, is compatible with microfluidics, brightfield, fluorescence, brightfield, and quantitative-phase imaging, as well as conventional sample mounting techniques, and is supported by open access software for image acquisition and processing.

The system may include a first detection objective for Raman, brightfield (BFI), fluorescence, and quantitative-phase imaging, and the same objective or a second objective for guiding the light-sheet illumination. Further, the light-sheet relies on various beam types, including non-diffracting beams. Any suitable spatially or temporally beam may be used, such as an Airy beam, an optical lattice, a Gaussian, and a Bessel beam. Such beams may be generated by a diffractive optical element (DOE), a spatial light modulator (SLM), or other passive optical elements, such as axicons and cylindrical lenses, or active optical elements, such as digital micromirror arrays. The light-sheet and one objective are configured such that detection and illumination take place in orthogonal directions. The imaging system includes a device for viewing, generating, and/or capturing an image, such as a camera or senor that can detect individual photons or exhibit single photon sensitivity. In one particular embodiment, the imaging system is configured to combine Airy beam light-sheet microscopy for 3D Raman imaging with brightfield and quantitative-phase on to a microscope frame.

An individual with common skill in the art will realize that the disclosed imaging system may include other components and features that facilitate or moderately alter operation. For example, the imaging system may require a single pixel detector or an 1D pixel array, or compressive sampling to acquire the Raman or BFI image; and the system may require a second diffractive or polarization component to reconstruct an optical-phase image; the system may also require a dispersive or interferometric optical element to decipher spectral information; the system may also scan a two-dimensional (2D) illumination beam to generate the light-sheet, or may also apply a one-dimensional (1D) illumination beam to generate the light-sheet without scanning; the system may also harness artificial intelligence or deep learning models to reconstruct the photon sparse images.

Specific disclosed embodiments are designed for integration with commercially-available microscope frames that provide the first and/or second objectives and the sample holder. In an exemplary embodiment, the microscope was integrated with an automated stage that was configured to position or scan the sample in 3 directions. In the same embodiment, the microscope stage included a piezo stage, two linear stages, and a MEMS scanning mirror. The MEMS mirror guided the illumination beam to the sample, in synchrony with the piezo and linear stages to provide 3D Raman imaging. To obtain 3D images, the piezo stage scanned sample vertically, in an axis perpendicular to a illumination plane formed by the scanning beam via the MEMS mirror.

As another feature of disclosed embodiments, the imaging system may be used in combination with specific labels, such as stable isotopes, for extracting more information from the sample by Raman imaging, such as metabolic activity and pulse-chase kinetics for turnover information of key molecules or biomolecules, such as proteins. The isotopic labels may be advantageously supplied using a material or materials that cause no toxicity.

A specific embodiment of the disclosed system comprised a first objective of selectable levels of magnification for Raman, brightfield, fluorescence, brightfield, or quantitative-phase imaging. The specific embodiment also comprised of the same or a second objective of also selectable levels of magnification for guiding an Airy beam, Bessel beam, optical lattice, or Gaussian beam generated by a first spatial light modulator (SLM) to illuminate a sample with a beam. The imaging and illumination axes were configured orthogonally to each other. The imaging system further comprised a condenser to illuminate the sample with white light or monochromatic light. The imaging system also comprised an intensified CMOS (iCMOS) camera to acquire the photon-sparse images, as needed. Bandpass and reflecting dichroic filters directed the Raman signal to the iCMOS and transmitted white light to the same or a second sCMOS camera.

As another feature of disclosed embodiments, the imaging system may be used in combination with microfluidics, including a microfabricated receiver for retaining the imaging target. Microfluidics may be fabricated using advantageous material or material combinations that yield low non-specific signals, or exhibit a dielectric constant that matches the same constant of the sample medium, such as an aqueous medium. The disclosed system is particularly suitable for chemical or biological imaging applications. For these applications, one disclosed embodiment of a microfluidic sample receiver was made using a material having a refractive index of about 1.3 using agarose gel, polydimethilsiloxane, polyacrylamide, or combinations thereof.

The current invention also offers embodiments of a method for using the disclosed embodiments of the Raman imaging system. Certain applications include using the system for imaging a living system, such as a cell, or an organism. The imaging system may be used, for example, to image live cells, where light-sheet Raman imaging at the photon-sparse or single-photon levels provides information, such as three- or four-dimensional metabolic dynamics, or metabolic activity, while brightfield and quantitative-phase imaging provides label-free information concerning location, size and the optical phase delay of cells and organelles. Naturally, there are a plethora of other applications for the disclosed imaging system, such as imaging chemical reactions and their rates or constituents thereof.

The preceding and other features, advantages, and benefits of the invention will become clearer from the following detailed description, proceeding with reference to the accompanying figures.

### BRIEF DESCRIPTION OF THE DRAWINGS

FIG. 1 is a schematic drawing displaying an exemplary embodiment of an imaging system in accordance to the present invention comprising two objectives arranged orthogonally, one for detection (20×/0.5 or 40×/1.1) and one (20×/0.42) for guiding a beam, such as the Airy beam (LS) that is generated by a spatial light modulator (SLM) and scanned in the x-axis or x-direction with respect to a sample via a microelectromechanical (MEMS) mirror; the imaging system in accordance to the present invention also comprises of a condenser to guide white or monochromatic light to the sample and an epi-illumination path (epi), and wherein filter directs the signal to a photon-sparse detector (iCMOS detector) or alternatively a second conventional camera.

FIG. 2 is a schematic drawing displaying an exemplary embodiment of an imaging system as illustrated by FIG. 1 according to the present invention but comprising one objective that both generates a light-sheet and collects the signal generated by the light-sheet, provided that the light-sheet illumination path is significantly orthogonal to the detection objective.

FIG. 3 is a schematic drawing displaying an exemplary embodiment of the 3D distribution of the Airy illumination intensity in light-sheet Airy photon-sparse Raman imaging assembly, the experimental determination of the Airy light-sheet intensity, and its projection onto a multi-pixel photon-sparse detector. FIG. 3 also displays the 3D distribution of the Gaussian light-sheet illumination intensity, experimental characterization, and detector projection, as well as the 3D distribution of epi-illumination intensity, its experimental characterization, and detector projection.

FIG. 4 is a schematic illustrating an imaging assembly for generating an Airy beam, generating a light-sheet, and collecting images.

FIG. 5 represents a front view of a system in accordance with the present invention comprising the commercial microscope frame, the illumination objective, the detection objective, and a custom stage comprising two linear stages, a piezo stage and a sample receiver that enables access and, thus, sample illumination by a beam, such as an Airy beam, in the direction denoted by the arrows.

FIG. 6 represents a detailed back view of a system in accordance with the present invention comprising a commercial microscope frame and a light conduit for generating epi or LS illumination as drawn in FIG. 2.

FIG. 7 represents a side view of a system in accordance with the present invention comprising a commercial microscope frame, a scanner system, and a jack stage configured to move a beam scanner assembly and illumination objective for one embodiment of the present invention.

FIG. 8 displays a perspective view of sample holder and the evolution of the illuminating Airy beam with respect to the illumination objective, where the grey shaded area indicates the 800 μm thick and the bottom microfluidic surface (200 μm) that combined provide uninterrupted beam propagation until the sample.

FIG. 9 displays a table listing all tested samples and parameters, including the respective detection objective, irradiance, wavelength of excitation (λ_{exc}) and detection (λ_{det}), along with the correspondingly detected Raman band (ω_{Raman}), the photon-sparse (Tₚₛ) and conventional (Tc) pixel dwell times. All measurements displayed in this table were performed in n=5 replicates, and the mean±standard error is reported, where necessary.

FIG. 10 displays the corresponding spontaneous Raman spectra of all tested samples, with the employed Raman bands per sample highlighted in yellow.

FIG. 11 displays the experimental representation of the cross-sectional Raman intensity in a uniform polydimethilsiloxane slab of various Airy beams of different phase modulation parameters (a in mm⁻³), including one for a Gaussian beam (α=0 mm³).

FIG. 12 plots the photon variance (y-axis) as a function of the average number of collected photons (x-axis) for single, D₂O labelled Y. lipolytica cells using either 20× or 40× magnification objectives and various irradiance levels (the exact imaging conditions are detailed in FIG. 9); data points represent experimental observations at three different irradiance levels, while the thick red line represents the equivalent of a Poisson distribution (i.e., <ΔN²>=<N>).

FIG. 13 plots the photon variance (y-axis) as a function of the average number of collected photons (x-axis) for a single polydimethilsiloxane slab using either 20× or 40× magnification objective and various irradiance levels (imaging conditions detailed in FIG. 9); data points represent experimental observations at three different irradiance levels, while the thick red line represents the equivalent of a Poisson distribution (i.e., <ΔN²>=<N>).

FIG. 14 plots the photon variance (y-axis) as a function of the average number of collected photons (x-axis) for single polystyrene particles using 40× magnification objective (imaging conditions detailed in FIG. 9); data points represent experimental observations at three different irradiance levels, while the thick red line represents the equivalent of a Poisson distribution (i.e., <ΔN²>=<N>).

FIG. 15 plots the average photon number per pixel required for the Raman signal of Y. lipolytica, PDMS, and PS particles to converge to brightness levels with less than 5% error with respect to the ground truth for both conventional (left) Raman and photon-sparse (right) Airy light-sheet microscopy.

FIG. 16 displays the dependence of the pixel dwell times (y-axis) on the irradiance levels (x-axis) for Airy photon-sparse (Airyₚₛ), Gaussian photo-sparse (Gaussianₚₛ), conventional Airy (Airy_{C}), conventional Gaussian (Gaussian_{C}) and CARS/SRS (▴) microscopy. Data points correspond to PDMS (•), 1 μm polystyrene particles (▪), and Y. lipolytica cells (o)

FIG. 17 displays the Raman image of a polystyrene particle on resonance at ˜1,005 cm⁻¹ (“on”) and off resonance (“off” at ˜1,086 cm⁻¹). This measurement was performed at 20× magnification and 25 μW/μm² irradiance using the present invention.

FIG. 18 displays the Raman image of a polydimethylsiloxane slab on the bending asymmetric CHs resonance (“on” at ˜1,412 cm⁻¹), as well as off resonance (“off” at ˜963 cm⁻¹) and the pump laser switched off (“bg”). This measurement was performed at 20× magnification and 175 μW/μm² irradiance using the present invention.

FIG. 19 displays a series of sparse photon Raman images at the varying specified photon fluxes (i.e., photons (γ) per pixel) for a Yarrowia lipolytica cell (brightfield displayed in the inset) illuminated with an Airy light-sheet, including a magnified 3D view of the cell at 0.33 γ/pixel and the temporal signal trace of two pixels outside the cell contour (ρ₁ and ρ₂) and two from within (ρ₃ and ρ₄).

FIG. 20 displays a series of conventional sCMOS images at the varying specified photon fluxes (i.e., photons (γ) per pixel) for a Yarrowia lipolytica cell (brightfield displayed in the inset), including a magnified 3D view of the cell at 0.57 γ/pixel, along with the temporal signal trace of two pixels outside the cell contour (ρ₁ and ρ₂) and two from within (ps and ρ₄).

FIG. 21 displays the 3D metabolic activity example of a single Y. lipolytica cell (brightfield included in the inset) at increasing photon per voxel fluxes (displayed in γ/vox), including 0.6 γ/vox, 0.8 γ/vox, 2.9 γ/vox, and 5.9 γ/vox. FIG. 21 includes both photon clouds and reconstructed xy and xz images; the corresponding (average) error from the ground truth is displayed in green.

FIG. 22 displays how photon super-localization is performed in the present invention, with [x,y] representing the original iCMOS pixel coordinates that is 2-fold super-resolved in the underlying [i,j] coordinate system.

FIG. 23 compares the Y. lipolytica cell shown in FIG. 21 under pixel (left) and sub-pixel (right) projection; both yield a total of 80× magnification, albeit left has undergone digital magnification, while right has undergone sub-pixel projection by photon super-localization. The dotted-trace on the right denotes a spatially dependent inflection in the metabolic activity of the cell, which is not possible to observe on the left.

FIG. 24 plots the planar resolution of the 20×/0.5 (left) detection objective under photon localization (1×1) and super-localization (2×2) conditions. The data points represent the mean of n=5 independent measurements with 0.5 μm (20×) and 0.2 μm diameter polystyrene particles (error bars represent the SEM), while the legend displays the average resolution level for the 5 particles (as FWHM±SEM).

FIG. 25 plots the planar resolution of the 40×/1.1 (left) detection objective under photon localization (1×1) and super-localization (2×2) conditions. The data points represent the mean of n=5 independent measurements with 0.5 μm (20×) and 0.2 μm diameter polystyrene particles (error bars represent the SEM), while the legend displays the average resolution level for the 5 particles (as FWHM±SEM).

FIG. 26 displays the non-genetic cell-to-cell metabolic variability in Y. lipolytica using deuterated water (i.e., D₂O) as a biomarker (blue) for a total of n˜100 observations; the control in non-isotopic water (H₂O) is also plotted for comparison along with some key cell imaging examples in both D₂O and H₂O.

FIG. 27 displays the photostability of the Raman intensity of a single Y. lipolytica cell by continuously imaging the same cell in 4D (25 minutes total duration in 1 min steps), with key 3D cell images included in the inset.

FIG. 28 provides a brightfield (left) and Raman (right) image of several Yarrowia lipolytica cells; here, the Raman image was acquired in an epi-illumination configuration (40×, 10 sec sCMOS integration, ˜40 μm diameter spot, λ=735 nm) to indicate the elevated background levels and resulting poor contrast of D₂O labelled cells in comparison to the present invention.

### DETAILED DESCRIPTION

### I. Terms, Definitions and Abbreviations

The following explanations of terms and abbreviations are provided to enhance understanding of the current disclosure and to assist those with ordinary expertise in the field in implementing the current disclosure. As employed in this document, “comprising” is synonymous with “including,” and the singular terms “a,” “an,” or “the” encompass multiple references unless the context specifically indicates otherwise. The word “or” signifies either a single component of the mentioned alternative elements or a combination of two or more elements unless the context expressly suggests a different meaning.

Unless otherwise specified, all technical and scientific terms used in this document are intended to have the same meaning as commonly recognized by someone with average expertise in the field relevant to this disclosure. While methods and materials similar or equivalent to those detailed here can be employed in the application or examination of this disclosure, appropriate methods and materials are outlined below. The provided materials, methods, and examples are solely for illustration and should not be seen as restrictive. Additional aspects of the disclosure become clear from the detailed description that follows and the accompanying claims.

The mention of numerical ranges should be interpreted as including every individual number within that range, including the endpoints, unless stated otherwise. Unless indicated differently, all numerical values given for quantities of components, percentages, temperatures, times, and so on, in the specification or claims should be understood as being prefaced by the term “about.” Therefore, unless specified otherwise, the numerical parameters provided should be seen as approximate values that may vary based on the desired characteristics being sought and/or the detection limits of standard testing conditions/methods known in the field. When explicitly differentiating disclosed embodiments from the prior art, the numbers for the embodiments are not considered approximate unless the word “about” is explicitly used.
FOV: Field(s)-of-view.
LSI: Light-sheet imaging.
MEMS: Micro electrical mechanical mirror.
SLM: Spatial light modulator.
NA: numerical aperture.
PDMS: polydimethylsiloxane.
sCMOS: scientific complementary metal oxide semiconductor.
iCMOS: intensified complementary metal oxide semiconductor.
QPI: Quantitative-phase imaging.
γ: number of photons.

### II. Introduction

Raman scattering converts photons incident on to a target (cell, organism, or non-living matter) to distinct vibrational fingerprints depending on the cell's molecular content, with emerging probes greatly facilitating related investigations. However, Raman scattering represents only a modest fraction of all research and clinical imaging to-date. This is due to the ultralow Raman scattering cross-section of most biomolecules, where ˜1 in 10⁸ incident photons undergoes inelastic scattering. These cross-sections constrain Raman imaging within the low-light, or photon-sparse regime, where the particle nature of light is heightened, resulting in increased uncertainty in photon detection and noise. While operation under such conditions is possible by adopting long integrations, such approaches result in significantly reduced imaging rates. Shorter integration times are possible with coherent non-linear methods (such as CARS and SRS) at, however, irradiance levels (>100 mW/μm²) that exceed recently established phototoxicity and photodamage thresholds (˜5 mW/μm²). Clearly, Raman imaging at high frame-rates and low irradiance levels remains a key target in biotechnology and materials science.

Certain disclosed embodiments of the present invention concern Raman imaging at high frame-rates and low levels of irradiance, as exemplified by merging light-sheet microscopy and sparse-photon detection using a standard inverted microscope. For one exemplary embodiment using a self-accelerating Airy beam illumination pattern, this imaging system exhibited video imaging rates (>30 Hz or <400 nsec/pixel) and low irradiance levels (102 μW/μm²). Importantly, this invention is compatible with photon super-localization, thus, enabling the use of long working distance objectives in light-sheet microscopy, with increased magnification and no field-of-view (FOV) penalties. Further, this design is compatible with imaging both living and non-living targets and is compatible with microfluidics that alleviate some of the stringent culture and sample preparation techniques required by common imaging methods. The described integrated design is also compatible with brightfield (BFI), fluorescent, and quantitative-phase imaging, open-source software, and alternative microscope frames, making it accessible to the broader scientific community, including non-specialists.

As a representative example, the imaging assembly according to the present invention was used to image a microorganism, Yarrowia lipolytica. This imaging example revealed that clonal cells can exhibit distinct heterogeneity forms of metabolic activity. This live-cell imaging experiment represents one example of how the present imaging system can be applied to single-cell biology investigations with limited phototoxicity and increased photostability.

### III. Integrated Imaging Assembly

### A. Optical Setup

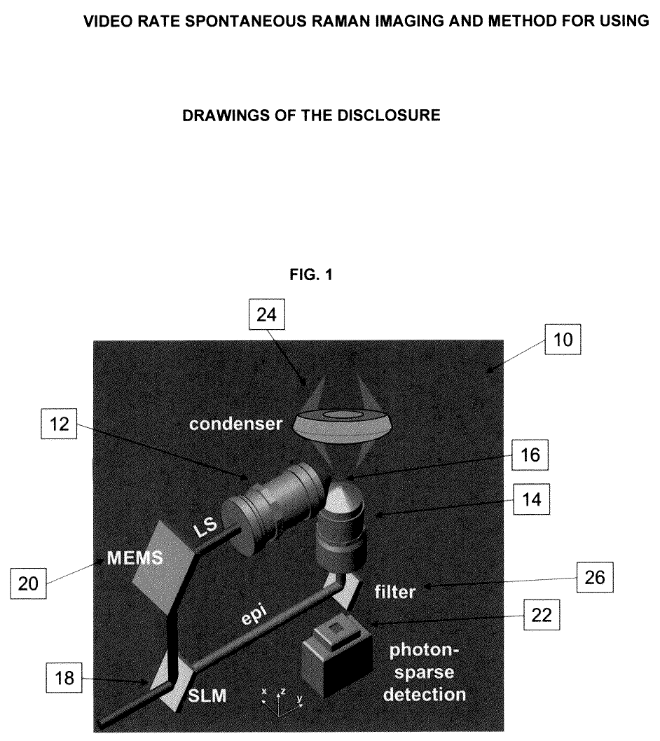

Embodiments of a light-sheet photon-sparse Raman imaging system according to the present invention are illustrated in FIGS. 1-7. The light-sheet photon-sparse Raman imaging system 10 combines an Airy beam light-sheet for 3D Raman imaging on to a standard inverted microscope. FIG. 1 provides a schematic illustration of an imaging set-up 10 in accordance to the present invention comprising two objectives 12, 14 arranged substantially orthogonally. A first objective 12 guides an accelerated Airy beam to a sample 16 enclosed in a microsystem. A second objective 14 is a detection objective. In the illustrated embodiment, objective 12 was a 20×/0.42 objective, and detection objective 14 was a 20×/0.5 or a 40×/1.1 objective. The Airy beam was generated by a spatial light modulator (SLM) 18 and scanned in the x-direction using a microelectromechanical mirror (MEMS) 20. The Raman image is recorded by a sparse-photon imaging camera 22. A condenser (0.55 NA, 2.8 cm working distance) 24 illuminated the sample 16 in a Koehler configuration, and the transmission is recorded by a sparse-photon or conventional CMOS camera 22 to reconstruct the bright-field or optical-phase image. The illustrated embodiment of the imaging system includes a filter 26 to direct the Raman signal to photon-sparse camera 22 and the transmitted white light to the same 22 or an alternative second camera (sCMOS). The Raman signal of the sample was guided via objective 14 onto a photon-sparse camera 22 while rejecting Rayleigh scattered light by filter 26. At this configuration, imaging system reconstructs Raman images of approximately 75,000 pixels and planar resolution of 0.89±0.03 μm (mean±standard error, determined by imaging n=5 polystyrene beads with a 200 nm diameter).

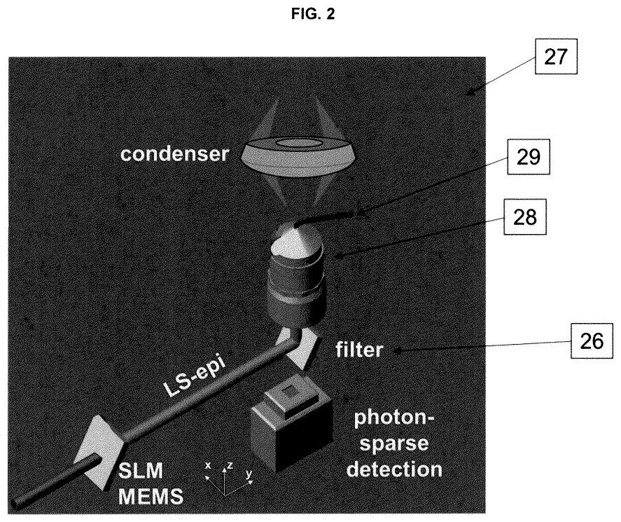

FIG. 2 illustrates a second embodiment of a disclosed photon-sparse Raman imaging system 27 according to the present invention substantially as illustrated by FIG. 1 that combines an Airy, Bessel, or Gaussian beam light-sheet for 3D Raman imaging using a standard inverted microscope. Imaging assembly 26 comprises one objective 28 that transmits the illuminating light-sheet 29 at a substantially orthogonal direction to the detection axis. In this embodiment, filter 26 guides also guides the illumination to the sample.

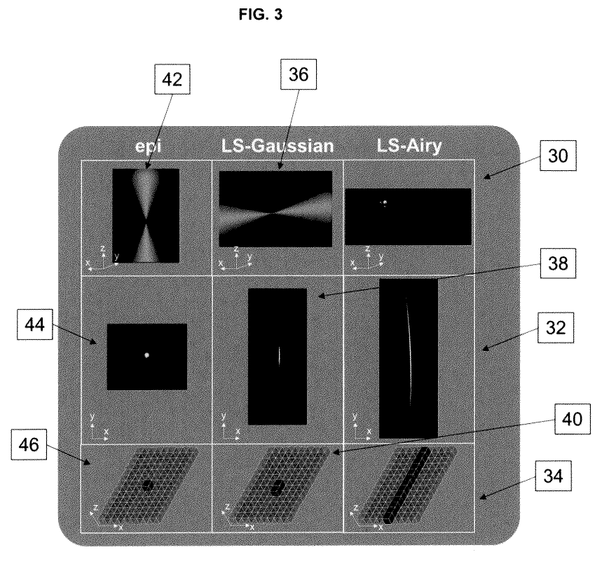

FIG. 3 is a schematic drawing displaying an exemplary embodiment of the 3D distribution of the Airy illumination in light-sheet Airy photon-sparse Raman imaging assembly 30, the experimental determination of the Airy light-sheet intensity by Raman imaging a uniform polydimethylsiloxane (PDMS) slab 32, and its projection onto a multi-pixel detector 34. FIG. 3 also displays the 3D distribution of the Gaussian light-sheet illumination intensity 36, its experimental determination in a uniform PDMS slab 38, and detector projection 40, as well as the 3D distribution of epi-illumination intensity 42. FIG. 3 also displays the experimental characterization in a uniform PDMS slab 44, and detector projection 46.

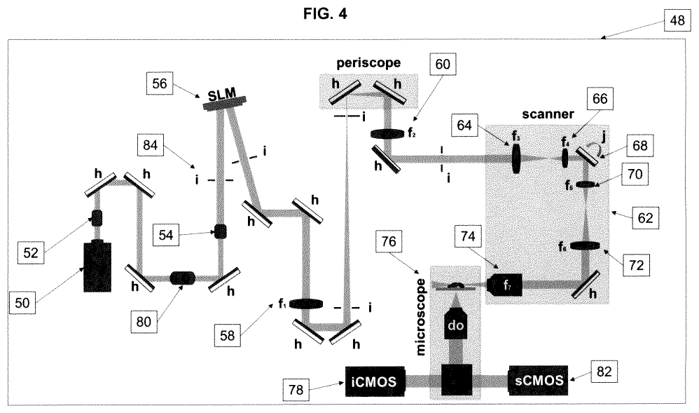

FIG. 4 provides a schematic representation of an exemplary light-sheet Airy photon-sparse Raman imaging assembly 48 for generating an Airy beam. Assembly 48 includes a laser source 50, such as a Matisse CR, Spectra Physics Titanium: Sapphire ring laser, 1 W, continuously tunable in the 700 nm-1,000 nm range, suitable for Raman spectroscopy. To ensure laser power stability, a motorized attenuator operating in a closed-loop format 52, such as a Newport VA-BB-2-CONEX, may be introduced in the beam path. The laser beam was expanded to a 4× with beam expander 54 and subsequently directed to a spatial light modulator 56 (MSP 1920-400-800-HSP8, Meadowlark Optics) that displayed a cubic phase mask (generated in Matlab, Mathworks), with the 0 and 2π phase levels corresponding to 0 and 255 gray levels, respectively. After the SLM, a 4f system was installed comprising an f1 lens 58 (75.6 cm) and an f2 lens 60 (40 cm). The f1 image was conjugated to SLM 56 (i.e., the SLM was placed at the back-focal plane of f1) and f2 was conjugated to a laser scanner 62 (i.e., the laser scanner was placed at the focal plane of f2). Scanner 62 included a second 4f system comprising an f3 lens 64 (3.5 cm) and an f4 lens 66 (1.2 cm), a 2D micro electro-mechanical mirror (MEMS) (MM) 68 (2.8 mm diameter, Mirrorcle Technologies), an f5 scan lens (7.5 cm) 70, an f6 tube lens 72 (30 cm), and a large working distance illumination objective 74 (20×/0.42, Mitutoyo). The large working distance illumination objective 74 was specifically employed to accommodate the distance the microscope frame extends along the y-axis (FIG. 1). The scanner was positioned on a custom-made 3D stage with a 5 cm travel range in all three axes, 1 μm resolution in the vertical axis and 10 μm planar resolution. The 3D stage enabled precise alignment of the focused Airy beam with the focal planes of the detection objective (20×/0.5 or a 40×/1.1, Leica). Microscope 76 was equipped with a focus stabilization system, as well as automation in the objective turret and filter wheel position. 3D Raman images were captured by an intensified CMOS (HiCAM Fluo, Lambert Instruments) 78 connected to one port of microscope 76 and comprised of a double-stage microchannel plate (MCP), a GaAs intensifier photocathode (P46 phosphor), and a 1280×1024 CMOS array. The iCMOS operated at 9.5 μsec long gate pulses, 100 kHz gating frequency, and 1 kHz CMOS readout rates. The gating electronics of iCMOS 78 also drove an electro-optic modulator (LM0202, Excelitas) 80 that in turn modulated laser beam at 100 kHz using. Brightfield, fluorescent, and quantitative-phase images were collected either by iCMOS 78 or by a scientific CMOS camera (ORCA-Flash 4.0, Hamamatsu) 82 connected to one port of microscope 76.

### B. Optical Alignment

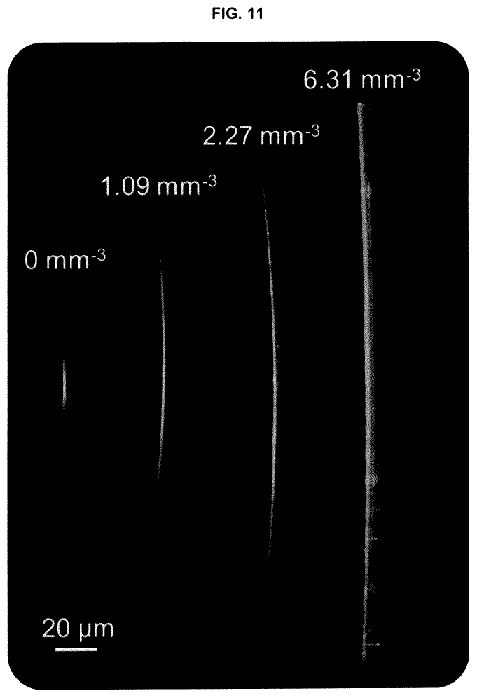

Irises 84 along the optical path (FIG. 4) ensured that the laser beam from laser 50 passed through the desired location of all optical elements and alignment inspection on a daily basis. The active SLM 56 pattern was aligned with the excitation beam using a CMOS camera (acA3800-14 μm, Basler). By inspecting the excitation beam profile at the image plane, any necessary adjustments in the positions of the scanner 62 and microscope 76 were made. Airy beam quality was inspected both with the stage-mounted CMOS camera and a uniform polydimethylsiloxane (PDMS) slab as a Raman target (FIG. 11).

### C. Custom Light-Sheet Microscope

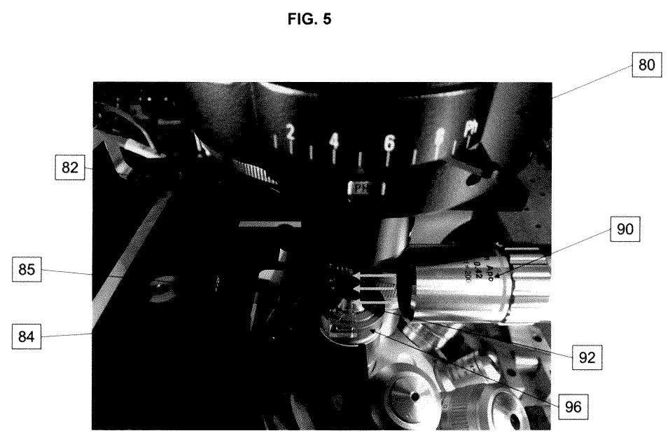

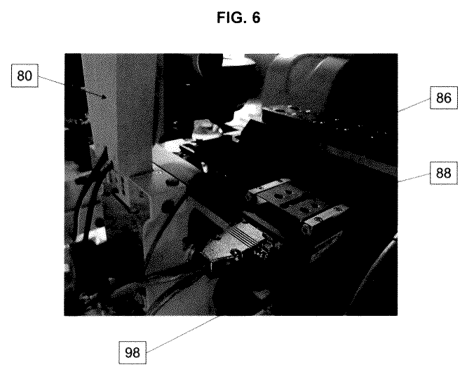

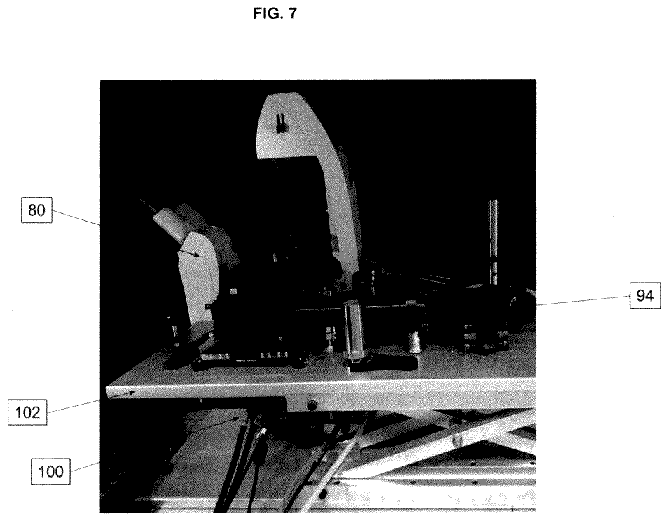

FIGS. 5-7 provide digital images of one embodiment light-sheet Airy photon-sparse Raman imaging assembly according to the present invention. FIG. 5 is a front view of an assembly according to the present invention comprising a commercial microscope 80 and the custom-built microscope stage 82. The custom-made stage 82 was used to position a sample and scan it in three directions for imaging. Stage 82 comprised a piezoelectric stage 84 (IPZ-3150, Applied Scientific Instrumentation) integrated with two linear stages (LS-50, Applied Scientific Instrumentation) 86, 88 (FIG. 6), each equipped with encoder resolution and large total travel range. Stage 84 also included a sample receiver 85, with the illumination direction 90 guiding the light-sheet on the sample via arrows 92. For acquisition, piezo stage 84, linear stages 86, 88, and 2D MEMS mirror 94 (FIG. 7) were synchronized using a controller (TG-1000-8, Applied Scientific Instrumentation) equipped with programmable logic, and communication cards. To enable 3D imaging at a single location, the sample was scanned vertically using piezo 84, and the Airy beam planarly using the MEMS mirror 94. Raman images were collected through detection objective 96 (FIG. 5) onto a photon-sparse detector 98 (FIG. 6). Brightfield, fluorescent, and quantitative-phase images were collected through the same detection objective 96 on to photon-sparse detector 98 (FIG. 6) or a conventional sCMOS camera 100 (FIG. 7).

FIG. 7 is a side view of a jack 102 configured to move a beam scanner assembly and illumination objective for one embodiment of the present invention.

Specific disclosed embodiments of light-sheet Airy photon-sparse Raman imaging assembly in accordance with the present invention were configured for use in combination with microfabricated microfluidic sample receiver 85 (FIG. 5) enclosing cells encapsulated in low temperature agarose. Both the agarose concentration and polymer material were chosen to exhibit a refractive index that is matched to water. One embodiment of a suitable agarose concentration is 1% in water. One embodiment of a suitable polymer is BIO-133, from My Polymers, which is a reduced-cytotoxicity, non-fluorescent, low refractive index UV curable optical polymer/coating/adhesive. One reason that low temperature agarose of certain concentration and BIO-133 are suitable is because they exhibit refractive index of 1.33, which minimizes image distortion.

The microfabricated microfluidic sample receiver 85 (FIG. 5) comprised a rectangular micro-container defined by 800 μm thick vertical sidewalls. This microsystem was fabricated first in polydimethylsiloxane (PDMS using conventional cast-molding lithography from a patterned SU8 coated Si wafer, and subsequently transferred to BIO-133 via UV lithography in a mask-aligner (Q4000-4, Quintel Corporation). Once cells were introduced into the micro-container with a pipette, the microsystem was enclosed with a coverslip coated with a 400 μm thick film of the same polymer. Fluid exchange was possible during cell loading or alternatively via external tubes.

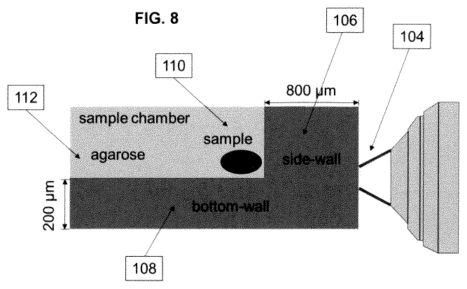

FIG. 8 illustrates the evolution of an Airy beam 104 dimension along the propagation direction of the y-axis (FIG. 1 and FIG. 2) with respect to the illumination objective 90 (FIG. 5), where the grey shaded area 106 indicates the 800 μm thick microfluidic system side-wall, illustrating that the vertical dimension of an Airy beam 104 used in one embodiment of the present invention is significantly less than the bottom polymer film 108 of the microfluidic system (200 μm), thus, providing uninterrupted light propagation until sample 110 embedded in an agarose matrix 112.

### D. Photon Sparse Imaging

Micro-Manager 1.4 was used for 3D Raman image acquisition. A PC (Z8, Hewlett-Packard) equipped with Intel Xeon W-2123 W CPU @ 3.60 GHZ processors and 128 GB RAM acquired and temporarily stored raw 3D images. For longer term storage, all data was transferred to a server. Images were analyzed using ImageJ on a workstation equipped with an Intel Core i7-7820X CPU @ 3.60 GHz processor and 128 GB RAM.

To image Raman scattered photons, we first blocked the Rayleigh scattered photons using appropriate filters (Alluxa). Raman scattered photons were then projected onto an iCMOS sensor (exhibiting 12-10-5+8-10-7 dark photon counts per pixel and CMOS frame; mean±standard deviation of n=11 replicates, with each replicate totaling 1,500 CMOS frames under no illumination). Connected to a workstation (128 GB RAM) via a CoaXPress interface (4-channel at 6.25 Gbit/see speed per channel), the iCMOS operated at 9.5 μsec long gate pulses, 100 kHz gating frequency, and 1 kHz CMOS readout rates. Under these conditions, the intensifier fired ˜100 times between two CMOS readout events with a 600,000 cd/m²/lx total gain. To ensure coincident illumination and photon collection, each gating pulse was synchronized with the electro-optic modulator via a 100 nsec delay. All images were first recorded in a 12-bit format in RAM and subsequently transferred to a solid-state drive in a 16-bit (tiff) format for further processing.

Due to pixel-to-pixel crosstalk at the amplification (MCP) stage, the acquired photons covered multiple pixels (i.e., formed photon clouds). A computational approach, similar to those employed in single molecule localization superesolution microscopy, reduced these photon-clouds to a single, unit-level pixel. This computational approach determined the centroid of each cloud by first thresholding the images (using the “imbinarize” Matlab command with the “adaptive” algorithm and a 0.2 “Sensitivity” parameter), thus, binarizing the regions of interest. Subsequently, watershed and centroid estimation (using the “regionprops” command in Matlab coupled to “centroid” parameter). For object/shape recognition, photon-sparse images were additionally processed by discrete wavelet transforms, and specifically PURE-LET, that applies the discrete wavelet Haar transform (DWT) as a two-channel filter-bank and recursively at decreasing resolution levels. In PURE-LET, denoising occurs by computing a threshold using a linear expansion of thresholds method that takes local noise variance into consideration. Other methods that can compute the intensity of Poisson or Poisson-Gaussian processes, including artificial intelligence, can also offered similar results to PURE-LET.

### E. Optical Model

To guide the design of the apparatus and its characterization, we constructed a theoretical model to predict the generation and propagation of the Airy beam, specifically for the setup displayed in FIG. 1, FIG. 2, and FIG. 3. In this model, the monochromatic electric field is described as:

$$\tilde{E} ( x , y , z ; t ) = E ( x , y , z ) {e}^{- i ω t} , \qquad ( 1 )$$

and the electric field profile E(x,y,z) at any γ can be re-written as the superposition of plane waves. As such, beam propagation can be analyzed in Fourier space as:

$$E ( x , y , z ) = \frac{1}{{( 2 π )}^{2}} \int {\int }_{- ∞}^{+ ∞} A ( {k}_{x} , {k}_{z} ; {y}_{0} ) {e}^{i ( {k}_{x} x + {k}_{z} z )} {e}^{{ik}_{y} y} {dk}_{x} {dk}_{z} , \qquad ( 2 )$$

where

k_{y}=\sqrt{k²−kₓ²−k_{z}²}

is the ŷ component of wavevector k, k=2 πn/λ, with n being the refractive index of the medium. In (2), parameter A (kₓ, k_{z}; y₀) represents the Fourier spectrum of the input electric field profile at y₀ and it can be obtained through Fourier transform:

$$A ( {k}_{x} , {k}_{z} ; {y}_{0} ) = \int {\int }_{- ∞}^{+ ∞} E ( x , {y}_{0} , z ) \cdot {e}^{- i \cdot ( {k}_{x} x + {k}_{z} z )} dx \cdot dz \qquad ( 3 )$$

We solved (2) and (3) numerically using the Fast Fourier Transform Beam Propagation Method (FFT-BPM) in MATLAB, thus, computing the field profile at any position along the y-axis, given an input field profile Eᵢₙ=E (x, y₀=0,z). As detailed in FIG. 1 and FIG. 2, we utilized a Gaussian beam modulated by a SLM cubic phase

$$ϕ = {e}^{\frac{i \cdot α \cdot ( {x}^{3} + {z}^{3} )}{3}}$$

as input electric field, i.e.,

$${E}_{i n} = {E}_{0} {e}^{- \frac{{x}^{2} + {z}^{2}}{2 \cdot {w}_{0}^{2}}} ϕ ,$$

where w₀ represents the Gaussian beam spot width at 1/e intensity, E₀ is the amplitude of the field and α denotes the scaling parameter of the cubic phase modulation. Given the input profile at y₀=0, the beam is then propagated through all individual optical components displayed in FIG. 4. The output beam Eᵢ(x, y, z) after the i-th lens with focal length fᵢ was determined by FFT-BPM:

$${E}_{i} ( x , z ) = {ℱ}^{- 1} \{ {A}_{i - 1} ( {k}_{x} , {k}_{z} ) {e}^{i \cdot {k}_{y} {d}_{i - 1 , i}} \} \times {T}_{i} ( x , z ) \qquad ( 4 )$$

where Aᵢ₋₁(kₓ, k_{z}) represents the angular spectrum of Eᵢ₋₁(x, z), i.e., Aᵢ₋₁(kₓ, k_{z})= [symbol] {Eᵢ₋₁(x, z)}, and

Tᵢ(x,z)=exp[−2π(x²+z²)/(2fᵢλ)]

represents the transmission function of the i-th lens and d_{i-1,i} is the distance between the (i−1)^{th} lens and i^{th} lens. Specifically, the beam profile after the first lens is

E₁= [symbol] ⁻¹{Aᵢₙ(kₓ,k_{z})e^{ikyd0}}×T₁(x,z),

with do being the distance between the SLM and the first lens. With this approach, we assessed the propagation characteristics of various Airy beams using the experimental parameters of W₀=3 mm as the width of the input Gaussian beam at a λ=734 nm wavelength.

### F. Sample Preparation

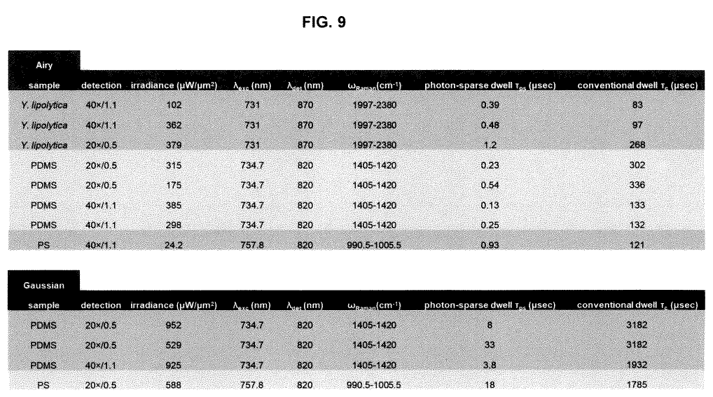

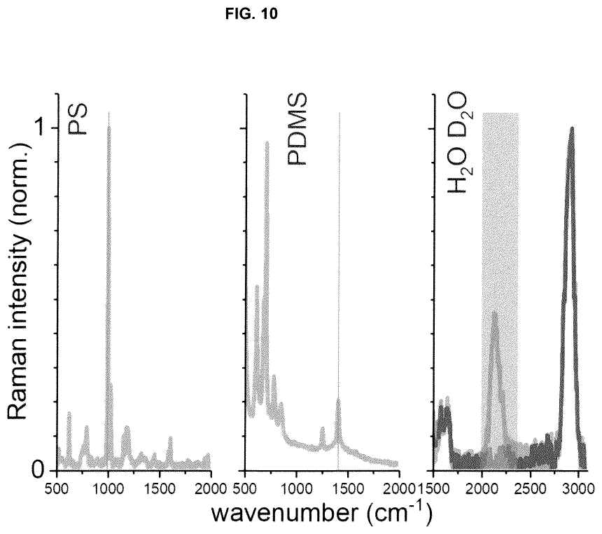

To evaluate the performance of the microscope, we imaged three samples. The first sample was Y. lipolytica cells. Prior to imaging, cells were grown for 24 hrs in a synthetic medium (YSM), where natural water was supplemented with deuterated water. To prepare these samples, cells were first passed from a frozen glycerol stock (−80° C.) to YPD plates and then twice in YPD for 24 hrs at 28° C., washed 3× in the defined medium YSM, and then passed again to YSM. To prepare YPD, we mixed 20 g/L Bacto Peptone (BD), 10 g/L yeast extract (Alfa Aesar), and 20 g/L glucose (Fisher). To prepare YSM, we mixed 1.7 g/L yeast nitrogen base without amino acids and without ammonium sulfate (BD Difco), 0.69 g/L complete supplement mixture (CSM) without Leucine (Sunrise Science Products), 0.1 g/L Leucine, and 1.1 g/L ammonium sulfate (Fisher) and 50 g/L glucose (Fisher). In the YSM medium, natural water (H₂O) was replaced with deuterated water (D₂O, Alfa Aesar). Prior to imaging, cells were embedded in low temperature agarose. We prepared this sample by mixing 1% agarose (Low Melting, Fisher) with YSM and dissolving the mixture in a convection oven at 80° C. for 45 min. Subsequently, we let the gel cool for ˜10 minutes at room temperature until ˜35° C. We then added the Y. lipolytica cells in the gel, mixed gently, and allowed the mixture to solidify in-between two coverslips for 15 min. This yielded a gel of ˜500 μm thickness. The second sample was a polydimethilsiloxane (PDMS, Sylgard 184, Dow Corning) slab. To prepare this sample, we mixed the PDMS monomer with its catalyst (10:1 ratio), de-gassed it, and then cured it for 2 h in a convection oven at 70° C. The third sample pertained to 1, 0.5, and 0.2 μm diameter polystyrene particles (Bangs Laboratories) em-bedded in an agarose gel using the same procedure as in cell encapsulation. Here, we employed a ˜10⁴ dilution from a particle suspension with a 1% solids concentration. For each of these three samples, we selected a specific excitation and detection wavelength, and, thus, a specific Raman band, as further detailed in FIG. 9. The respective spontaneous Raman spectra of all examined samples are displayed in FIG. 10.

### G. Light-Sheet Propagation Length Quantification

FIG. 11 provides data concerning an experimentally determined diffraction-free propagation length of Airy and Gaussian beams. This data was obtained by illuminating a homogeneous polydimethylsiloxane (PDMS) and quantifying the beam diameter (approximated by 1/e) through the lateral intensity distribution (along the x-axis in FIG. 1) at various propagation distances (along the y-axis in FIG. 1).

### H. Temporal Performance Analysis

To quantify the performance of Airy light-sheet photon-sparse imaging, all samples described in section F were imaged in n=5 replicates, using both photon-sparse (iCMOS) and conventional (sCMOS) detectors. Subsequently, the required number of CMOS frames (for its replicate) for brightness to converge to less than 5% error with respect to the ground truth determined temporal performance. Brightness was specifically quantified through the following expression:

$$ε = \frac{〈 N 〉}{Δ t} \qquad ( 5 )$$

An contrast as follows:

$$contrast = \frac{〈 {N}_{s i g} 〉 - 〈 {N}_{b g} 〉}{〈 {N}_{s i g} 〉 + 〈 {N}_{b g} 〉} \qquad ( 6 )$$

In expression (5), <N>represents the pixel-to-pixel average number of photons in an integration period of Δt, which is proportional to the number of CMOS frames. In expression (6), <N_{sig}> and <N_{bg}>correspond to the average number of photons per pixel from signal and background regions of interest, respectively. To quantify brightness under photon-sparse conditions, iCMOS images that had undergone photon-cloud centroid estimation were employed. For conventional light-sheet imaging (relying on a sCMOS camera), (N) was replaced with the average pixel-to-pixel intensity (I) after background correction (Subtract Background, 50 pixel radius, ImageJ).

To establish the ground truth in each sample, the ˜3000^{th} CMOS frame that typically considered. The number of CMOS frames was employed to determine both the required integration times (at 1 KHz acquisition rates) and the required photon-flux per pixel. For the latter, we counted the number of collected photons in the region of interest. To convert these integration times to pixel dwell times, the convergence integration times were divided by the number of illuminated pixels (˜75,000 pixels using the 40× objective and ˜30,000 pixels using the 20× objective).

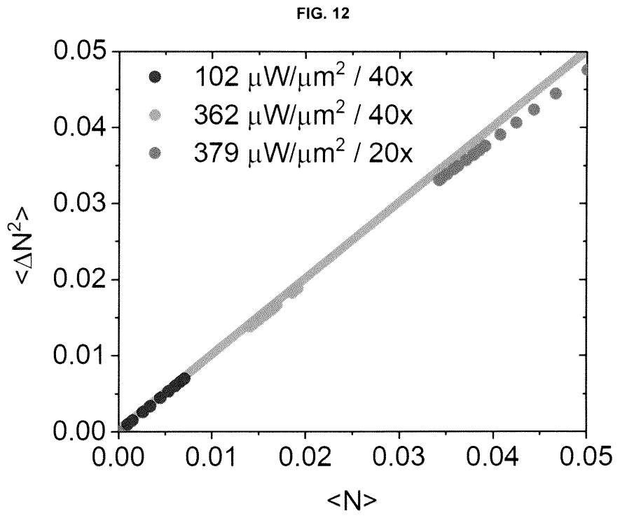

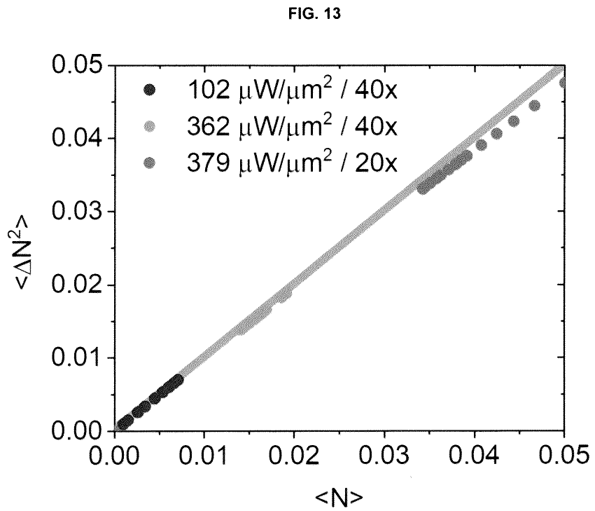

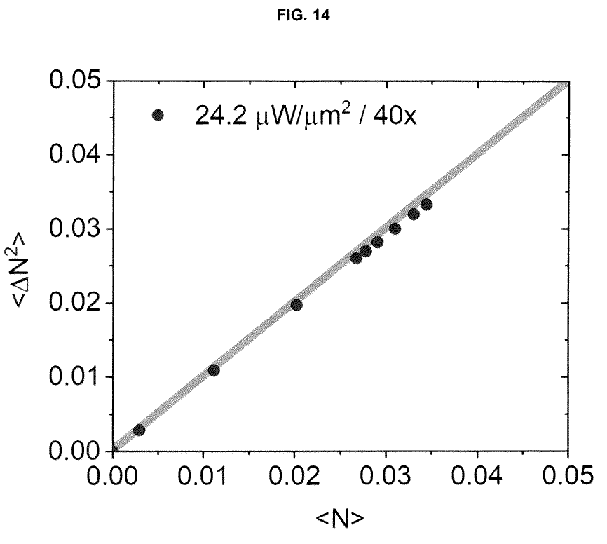

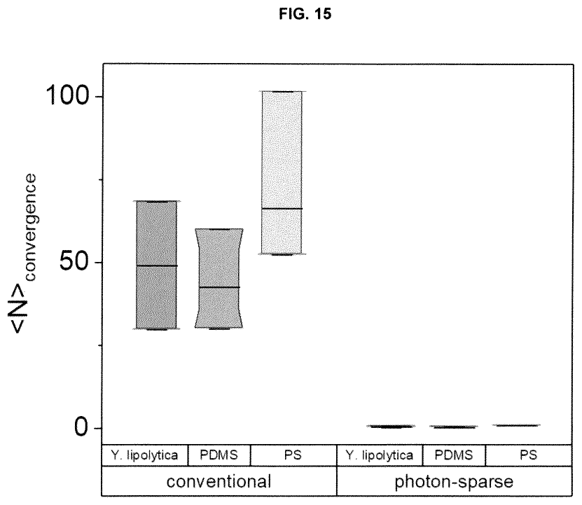

All samples exhibited temporal fluctuations in brightness. In all samples, these temporal fluctuations were characterized by a Poisson process, as displayed in FIGS. 12-14. The integration times required for the average brightness of all replicates (n=5) to converge to less than 5% error was used as a temporal performance metric. The metrics for all types of samples explored here are displayed in the table of FIG. 9. Photon-sparse brightness convergence times (dwell time) were compared with those conferred by conventional light-sheet microscopy (i.e., for example those light-sheet microscopy systems that are equipped with a sCMOS). In all samples and irradiance levels investigated, photon-sparse detection exhibited at least 2 orders of magnitude faster convergence, or equivalently required 2 orders of magnitude fewer photons. These results are displayed in FIG. 15.

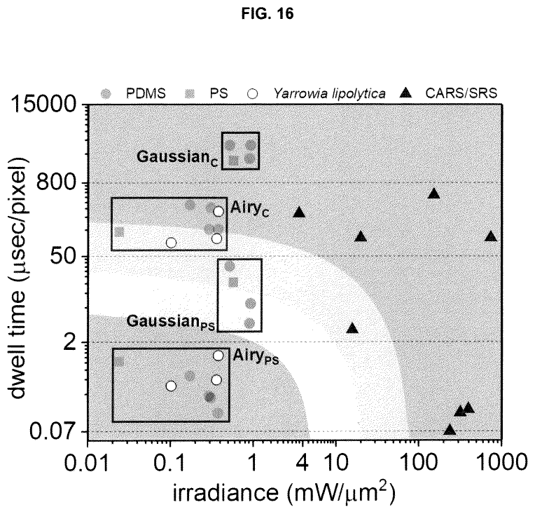

By considering the total illumination area (˜75,000 pixels at 40× magnification and 30 μm scanning range along the x-axis in FIG. 1) bestowed by the Airy beam, 380 nsec pixel dwell times for brightness to converge to 3.32+1.02% error (n=5 replicates) was determined for cell imaging. FIG. 16 summarizes all our measurements of all examined samples, where detection that is either capable of photon-sparse detection (iCMOS) or not (sCMOS), and illumination is characterized by diffraction-free propagation (Airy) or not (Gaussian). As illustrated in FIG. 16, light-sheet illumination relying on the accelerating Airy beam and conventional detection (sCMOS) did not confer significant gains, by yielding >50 μsec/pixel dwell times. Photon-sparse detection combined with Gaussian light-sheet illumination also did not yield considerable gains in imaging rates, constrained to >2 μsec/pixel dwell times (FIG. 16). Importantly, the considerable gains of convergence times less than 400 nsec/pixel emerge only upon combining photon-sparse imaging with the efficient illumination of large specimen regions, as uniquely bestowed by the extraordinary properties of the accelerating Airy beam (FIG. 16).

### H. Hyperspectral Imaging

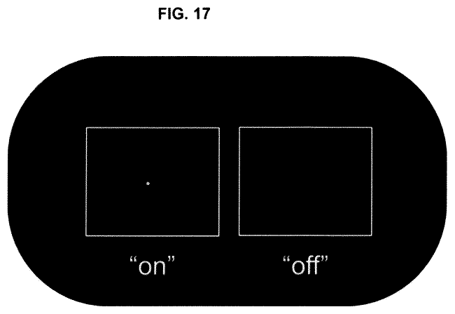

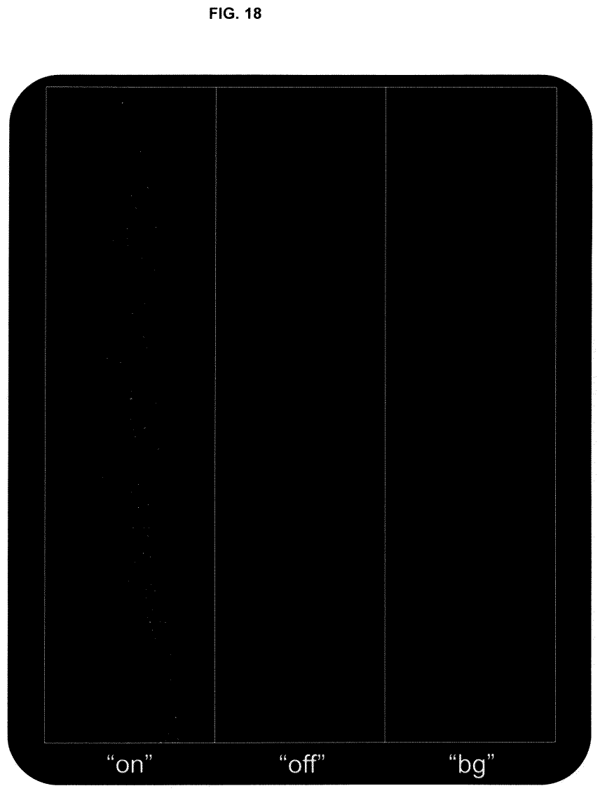

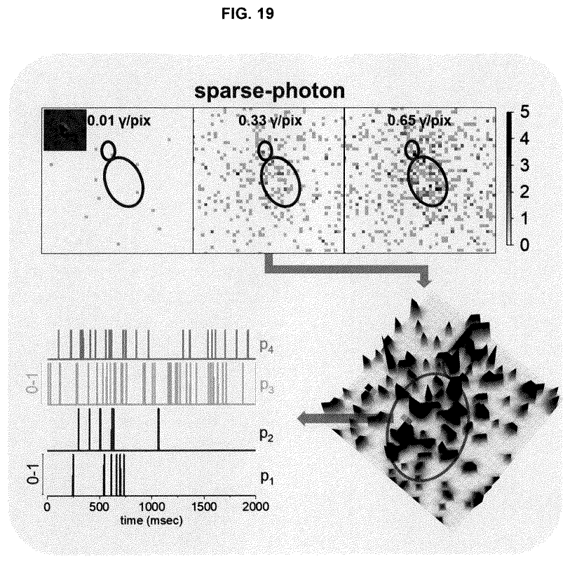

To acquire photon-sparse images of selective Raman bands in various samples (FIG. 9 and FIG. 10), the pump laser frequency was tuned with respect to the narrow transmission band of filters that otherwise rejected the Rayleigh scattered light. In this way, select Raman bands were imaged by tuning the laser and accordingly shifting the Raman scattered spectrum with respect to a spectrally-bound transmission window. In this way, the breathing mode of the aromatic carbon ring (˜1000 cm⁻¹) for polystyrene (PS) and the bending asymmetric CH₃(˜1,400 cm⁻¹) for polydimethylsiloxane (PDMS) was achieved. These results are displayed in FIG. 17 and FIG. 18, respectively. This approach also enabled the selective imaging of characteristic bands within the cell-silent Raman region (˜2,000 cm−1-2,400 cm⁻¹) of isotopically labelled cells (FIG. 19).

### I. Spatial Performance Analysis

All samples expressed the stochastic (random) nature of photon-sparse detection. One such example is displayed in FIG. 19 for a single Yarrowia lipolytica cell grown in defined media amended with the stable isotope heavy water (deuterium oxide, D₂O) as a marker of metabolic activity. Further, and as expected for shot-noise limited detection, these single photon dynamics exhibited Poisson distribution, with the variance in the number of detected photons equal to their average in all samples and irradiance conditions that we investigated.

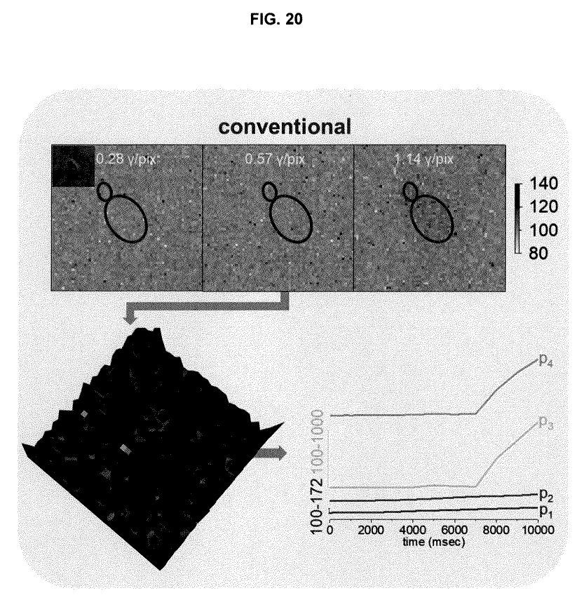

Ergodically, these Poisson dynamics translated to spatially random intensity variations, with the few pixels reporting the arrival of a photon being surrounded by many others that remained dark (FIG. 19). It is worth emphasizing that conventional light-sheet microscopy not harnessing photon-sparsity was unable to detect any metabolic activity in the same Y. lipolytica cell at similar integration times, irradiance, and, thus, signal (photon flux) levels, as per FIG. 20. In contrast, the Raman signal in conventional microscopy was buried under noise levels, until longer (6-8 sec) integration times provided an adequate number of photons (FIG. 20).

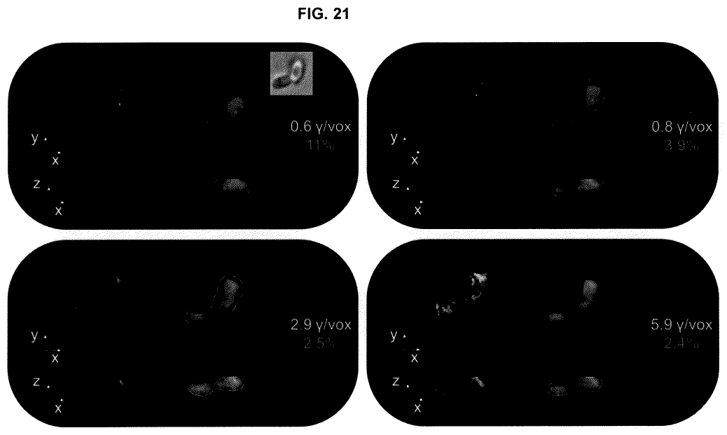

Despite the spatiotemporal randomness of photon-sparse detection, it was possible for the present invention to identify the 3D contour of elevated cellular metabolic activity, after denoising the photon-centroid images by PURE-LET. Per way of example, a single Y. lipolytica cell is shown in FIG. 21, analyzing the number of photons per voxel required to adequately represent the 3D cellular regions of elevated metabolic activity. FIG. 21 reports that sub-photon (0.8 γ) per voxel levels were required for 3D metabolic imaging to less than 5% error with respect to the ground truth.

### J. Magnification Enhancement

As encountered in the majority of light-sheet microscopy systems, geometrical constraints in the present invention also required the use of long-working distance and, as such, low magnification objectives (20× and 40×). This magnification constraint led to sampling rates below the Nyquist or Shannon limit (approximately 2.3-fold lower for a 40× objective and the iCMOS of a 6.6 μm pixel size) that, inevitably, reduced the imaging resolution.

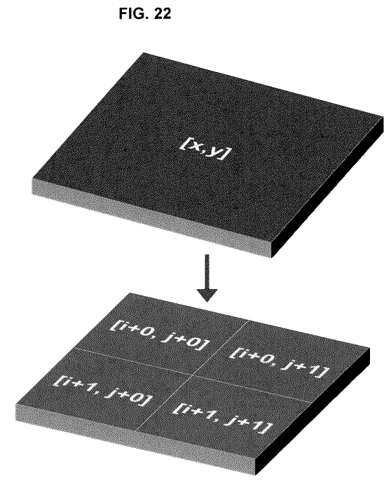

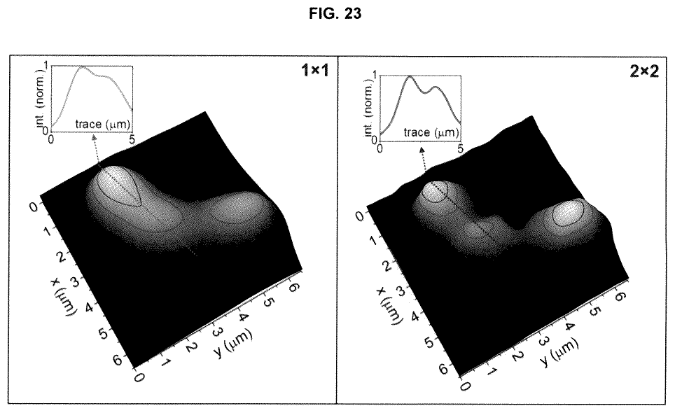

To overcome this limitation, the centroid of each detected cloud was localized to a 2-fold finer pixel grid than that bestowed by the iCMOS pixel array, as detailed in FIG. 22. This photon super-localization approach increased the magnification of the Raman cell image by a factor of 2. As per FIG. 23, the increased magnification improved the localization of the metabolic activity within a microbial yeast cell, revealing an inflection in metabolic activity at approximately midway the cytosol. It is worth noting that the same inflection was not detectable by an equivalent 2-fold digital magnification (ImageJ), as per FIG. 23.

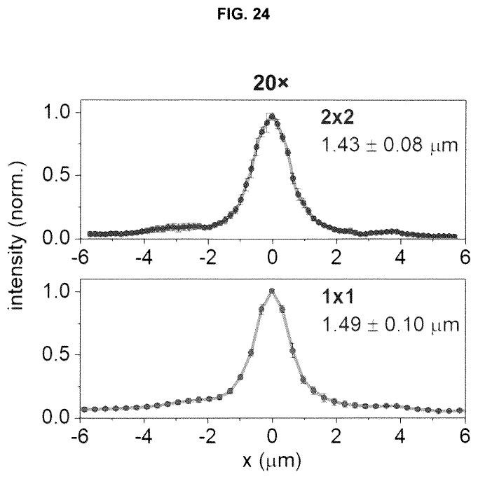

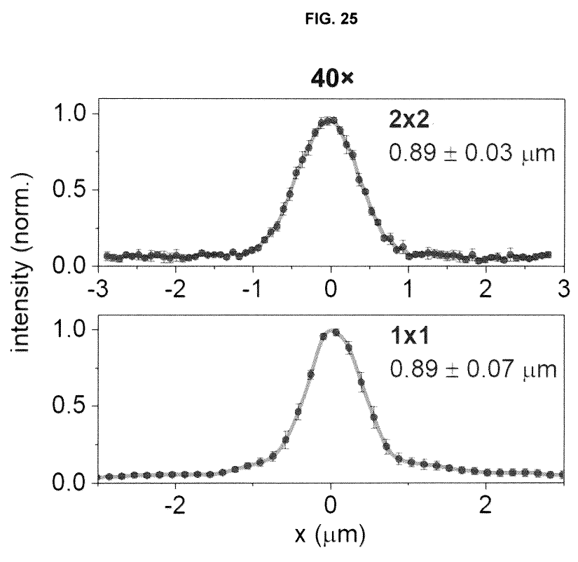

Further, photon super-localization required approximately a 4-fold higher photon-fluxes. This directly translates to minimal effects on pixel dwell times due to the similarly increased number of pixels. Importantly, this level of magnification relies strictly on the particle nature of light, without any additional optical elements on the imaging path. As such, photon super-localization incurs no apparent field-of-view and spatial resolution penalties. The latter is illustrated in FIG. 24 and FIG. 25 (averages of n=5 replicated presented as the mean±standard error), where the sizes of subwavelength particles evidence identical resolution levels under photon localization and super-localization conditions for the 20× and 40× imaging objectives.

### K. Discussion

As disclosed herein, exemplary embodiments of photon-sparse Raman light-sheet imaging system combined an Airy beam light-sheet for 3D Raman imaging with photon-sparse detection on to a standard inverted microscope (FIG. 1). Specifically, a self-accelerating Airy beam was used for Raman light-sheet excitation. The set-up for generating the Airy beam discussed above comprised a spatial light modulator 56 in FIG. 4 that exhibited an appropriate cubic phase mask. This mask was imaged to the back focal plane of an illumination objective (20×/0.42) 90 in FIG. 5. The illumination objective was positioned orthogonally to the detection objective 96 in FIG. 5.

Importantly, disclosed imaging systems implemented a single photon or photon-sparse imaging detector 78 in FIG. 4 or 98 in FIG. 6 that collected Raman images comprising of single photons. Such detection in combination with Airy light-sheet illumination enables video-rate Raman imaging in a variety of samples, as per FIGS. 9-21. Such detection also enabled photon super-localization (FIG. 22) and, thus, 2-fold improved magnification, as per FIG. 23, without any additional optical elements on the imaging path. As such, photon super-localization incurs no apparent field-of-view and spatial resolution penalties, as per FIG. 24 and FIG. 25.

Disclosed imaging systems implemented a long working distance illumination objective 90 in FIG. 5 and a custom-made 3D microscope stage 84 in FIG. 5 to enable Raman excitation without obstructing brightfield or quantitative-phase imaging. Light-sheet illumination was facilitated by microfluidics fabricated in polymer that was index-matched to water to eliminate optical aberrations at the polymer with dimensions that did not distort the Airy beam (FIG. 8).

### L. Performance

All samples exhibited temporal fluctuations in brightness that were characterized by a Poisson process (FIGS. 12-14). As per FIG. 16, Airy-light sheet illumination combined with photon-sparse detection conferred less than 400 nsec/pixel for sample brightness to converge. As per FIGS. 17 and 18, disclosed imaging systems enabled imaging of selective Raman bands, such as specifically the breathing mode of the aromatic carbon ring (˜1000 cm⁻¹) in polystyrene and the bending asymmetric CH₃ (˜1,400 cm⁻¹) in polydimethylsiloxane.

Despite the spatiotemporal randomness of photon-sparse detection, the 3D contour of elevated cellular metabolic activity was possible to detect with present invention, after denoising the photon-centroid images. As per FIG. 21, a Y. lipolytica cell required sub-photon (0.8 v) per voxel levels to adequately represent the 3D cellular regions of elevated metabolic activity with less than 5% error. Further, photon super-localization (FIG. 22) overcome common geometrical constraints in light-sheet microscopy that the use require long-working distance and, thus, low magnification objectives. As per FIG. 23, photon super-localization increased magnification, without any additional optical elements on the imaging path, thus, incurring no field-of-view and spatial resolution penalties (FIGS. 24 and 25).

### M. Imaging

Raman scattering converts photons incident on to a target to distinct vibrational fingerprints, with emerging Raman probes greatly facilitating related investigations. However, Raman scattering represents only a modest fraction of all research and clinical imaging to-date. This is due to the low Raman scattering cross-section of most molecules. These low cross-sections constrain Raman imaging within the photon-sparse regime, where the particle nature of light is heightened, resulting in increased uncertainty in photon detection. Operation under such conditions is possible by long integrations or >100 mW/μm² irradiance levels; such approaches, however, result in significantly low imaging rates, or irradiance levels that exceed known phototoxicity and photodamage thresholds (˜5 mW/μm²).

Disclosed embodiments of the present invention enable video-rate Raman imaging at low levels of irradiance. Certain exemplary embodiments used a self-accelerating Airy beam illumination pattern. Certain exemplary embodiments used sparse-photon detection. These exemplary systems exhibited video imaging rates (>30 Hz imaging rates or <400 nsec/pixel dwell times) and low irradiance levels (102 μW/μm²). Importantly, this design is compatible with photon super-localization, enabling the use of long working distance objectives in light-sheet microscopy, with increased magnification and no field-of-view penalties. Further, this design is compatible with imaging both living and non-living targets and is compatible with microfluidics that alleviate some of the stringent culture and sample preparation techniques required by common imaging methods. The described integrated design is also compatible with bright field imaging (BFI) and quantitative-phase imaging, as well as open-source software, and alternative microscope frames, making it accessible to the broader scientific community, including non-specialists.

As a representative example, the imaging assembly in accordance with the present invention was used to image a microbial eukaryotic organism, Yarrowia lipolytica. This imaging example revealed that clonal cells can exhibit distinct heterogeneity forms of metabolic activity, even if grown under identical nutrient conditions. This imaging example also revealed that cells can be 3D imaged for prolonged duration with exceptional photostability. This live-cell imaging experiment represents one example of how the present imaging system can be applied to single-cell biology investigations with limited phototoxicity and increased photostability.

### N. EXAMPLES

The subsequent examples are presented to illustrate certain features of exemplary embodiments of the present invention. An individual of ordinary skill in the art will appreciate that the range of the present invention is not limited to the characteristics of these representative examples.

### Example 1

This example illustrates the hyperspectral imaging capabilities of the Raman photon-sparse Airy LS system of FIG. 1 by tuning the laser excitation wavelength. In FIG. 17, a PS particle is imaged on resonance at ˜1,005 cm⁻¹ (“on”, <N>=0.8) and off resonance (“off” at ˜1,086 cm⁻¹, <N>=0.03). This measurement was performed at 20× magnification and 25 μW/μm² irradiance with the acquired centroid images subjected to PURE-LET denoising. FIG. 18 displays the Raman image of a polydimethylsiloxane slab at the bending asymmetric CH₃ resonance (“on” at ˜1,412 cm⁻¹), as well as off resonance (“off” at ˜963 cm⁻¹) and the pump laser switched off (“bg”). This measurement was performed at 20× magnification and 175 μW/μm² irradiance using the present invention.

### Example 2

This example illustrates the resolving power of the Raman photon-sparse Airy LS system of FIG. 1 along the xy-plane. For this, 500 nm and 200 nm diameter non-fluorescent PS particles embedded in a non-scattering matrix were used. The full-width-at-half-maximum (FWHM) along the xy-plane was 1.490+0.100 μm (mean±standard error, n=5, FIG. 24) for 20× magnification and 0.890 ±0.070 μm (mean±standard error, n=5, FIG. 25) for 40× magnification. These value was obtained under pixel-level photon localization conditions (1×1). Under photon super-localization conditions (2×2), these values remained similar indicating that photon super-localization improves magnification without hindering resolution.

### Example 3

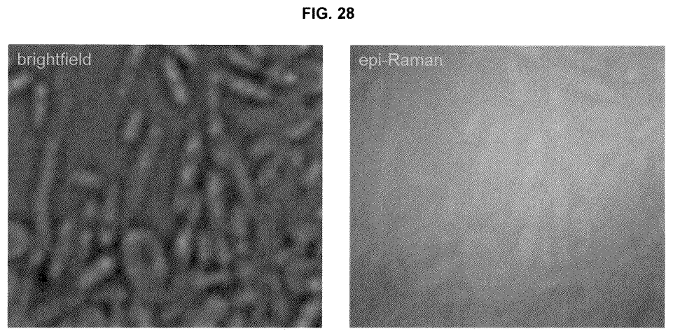

This example demonstrates the applicability of the Raman photon-sparse Airy LS system of FIG. 1 in the 3D imaging of biological specimens. A representative live-cell, 3D Raman image in microfluidics using the oleaginous yeast Yarrowia lipolytica is presented in FIG. 21. This model biosystem was selected for its importance in the production of 2^{nd} generation biofuels. The image panel of FIG. 21 displays the 3D metabolic activity of the same Y. lipolytica cell at increasing photon (γ) fluxes per voxel, namely: 0.6 γ/voxel, 0.8 γ/vox, 2.9 γ/vox, and 5.9 γ/vox. This panel of the Y. lipolytica cell images includes both photon clouds (left) and reconstructed (right) images along the xy and xz planes (planes and axes are noted in FIG. 1). Increasing photon fluxes indicate a reduced average error in determining the 3D metabolic activity of the cell in the xy and xz planes (FIG. 1). Specifically, a 0.6 γ/vox flux indicates an 11% error in 3D (i.e., volumetric) phenotyping of metabolic activity. Moreover, a 0.8 γ/vox flux indicates a 3.9% error, a 2.9 γ/vox flux indicates a 2.5% error, and a 5.9 γ/vox flux indicates a 2.4% error. As per FIG. 19 also, a brightfield image of the same cell is included in the inset, evidencing the multimodal imaging capabilities of the present invention. In this context, the apparatus enables cell imaging both in Raman and brightfield, fluorescent, and quantitative-phase imaging. The Raman wavelength can also be switched to enable fluorescent imaging. Finally, this example demonstrates the increased imaging contrast bestowed by light-sheet imaging, contrary to epi-illumination architectures that exhibit increased background, as shown in FIG. 28.

### Example 4

The example in FIG. 23 demonstrates how photon-cloud centroid projection with subpixel resolution (or photon super-localization, as described in FIG. 22) improves magnification without cost in the field-of-view or resolution. Specifically, a comparison of a Y. lipolytica cell is shown under pixel (1×1) and sub-pixel (2×2) projection; both (1×1) and (2×2) yield a total of 80× magnification, albeit (1×1) has undergone digital magnification in ImageJ, while (2×2) has undergone sub-pixel projection by photon super-localization. The dotted-trace along in (2×2) clearly denotes a spatially dependent inflection in the metabolic activity of the cell, which is not possible to observe in (1×1), indicative of the increased level of magnification and, thus, resolution. Overall, this example demonstrates the possibility of increasing imaging magnification by photon super-localization without a penalty to the field-of-view or resolution (FIGS. 24 and 25). This possibility is important in the field of light-sheet microscopy, where geometrical constraints require the use of long working distance and, thus, low-NA objectives. Inevitably, these objectives limit the available resolution, a limitation that can be lifted by photon super-localization.

### Example 5

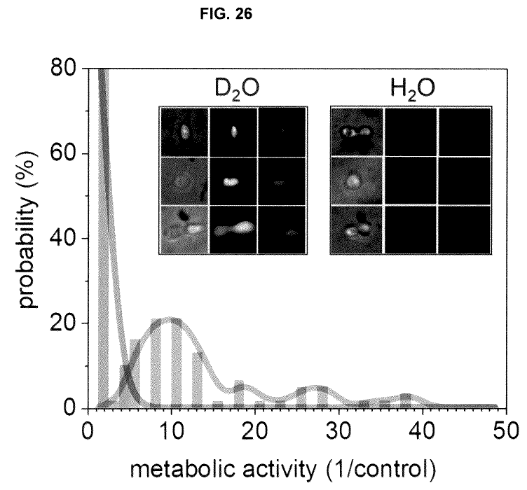

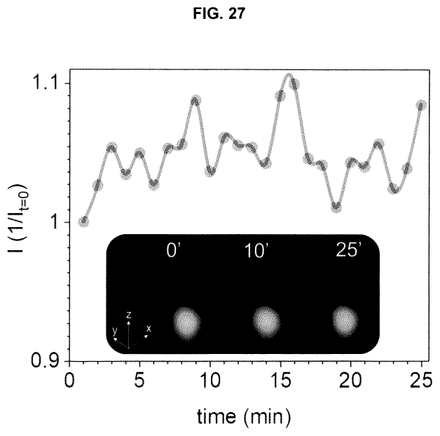

The example in FIG. 26 demonstrates a single-cell biology investigation, where the present invention reveals the non-genetic cell-to-cell metabolic variability in Y. lipolytica. Here, deuterated water (i.e., D₂O) was employed as a biomarker of metabolic activity. The histogram plots a total of n˜100 observations, and compared to the control of H₂O, along with some key cell imaging examples in both D₂O and H₂O (inset). The example in FIG. 27 demonstrates the photostability of the Raman intensity of a single Y. lipolytica cell by continuously imaging the same cell in 4D (25 minutes total duration in 1 min steps), with key 3D cell images included in the inset. Overall, this example demonstrates the applicability of the present invention in biological imaging with increased photostability, compatibility with existing Raman biomarker tags (such as D₂O), and increased resolution.

We claim:

1. An imaging system, comprising a light-sheet imaging system and detection at the photon-sparse, single photon, or light quanta levels.

2. The imaging system according to claim 1, comprising:
a first detection objective for Raman, fluorescence, brightfield, or quantitative-phase imaging;
a second objective for guiding a diffraction-free beam, wherein the first and second objectives are configured so that illumination and detection are arranged orthogonally; and
a device for viewing, generating and/or capturing a photon-sparse, single photon, or light quanta image.

3. The integrated assembly according to claim 2, wherein the diffraction-free beam is an Airy beam, a Bessel beam, an optical lattice, or a Gaussian beam.

4. The imaging system according to claim 3 wherein the Airy beam, Bessel beam, optical lattice, or Gaussian beam are generated by a first spatial light modulator (SLM).

5. The imaging system according to claim 1 configured to combine brightfield imaging with an Airy beam light-sheet for 3D Raman imaging on to a standard inverted microscope.

6. The imaging system according to claim 1 comprising an Airy beam generated by a spatial light modulator (SLM) and configured to scan a sample in a selected direction.

7. The imaging system according to claim 1 wherein transmission is accordingly encoded to reconstruct an optical-phase image.

8. The imaging system according to claim 1 further comprising a filter to direct a Raman signal to a first camera and transmitted or fluorescent light to the same or a second camera.

9. The system according to claim 1 enabling photon super-localization for improving magnification and resolution.

10. The system according to claim 1 enabling reconstruction of photon-sparse or single photon images using computer vision or deep learning approaches.

11. The system according to claim 1 further comprising a microfluidic receiver for housing a sample, wherein the microfluidic system is manufactured using a material or materials having a refractive index or indices substantially matching the refractive index of a sample medium.

12. The system according to claim 9 wherein the sample medium is aqueous.

13. The system according to claim 9 wherein the sample medium is agarose.

14. The system according to claim 9 wherein the sample comprises cells and/or tissue, and the material has a refractive index of about 1.3.

15. The system according to claim 9 wherein the material is a polymer selected from a MYPOLYMER material, agarose, polystyrene, polymethylmethacrylate, polyacrylamide, or combinations thereof.

16. The system according to claim 1 configured to include objectives having different levels of magnification from 1× to 100×.

17. The system according to claim 1 wherein the device for a device for viewing, generating and/or capturing an image is a camera.

18. The imaging system according to claim 1, comprising:
a first detection objective for Raman, fluorescence, brightfield, or quantitative-phase imaging;
a second objective or the same first objective for guiding an Airy beam generated by a first spatial light modulator to a sample enclosed in a microfluidic system, wherein the first and second objectives are arranged orthogonally;
a condenser to guide white illumination to the sample; and
a filter to direct Raman or fluorescence signal to a single-photon or photon-sparse camera and transmitted white light to the same or second camera;

19. The imaging system according to claim 2 comprising a microscope that provides a microscope stage configured to position a sample for scanning in 3 directions and the detection objective.

20. The imaging system according to claim 19 wherein the microscope stage includes linear and piezo stages.

21. The imaging system according to claim 20 further housing a MEMS mirror for planarly scanning the illumination beam in synchrony with the stage motion.

22. An imaging system, comprising:
a first detection objective to provide Raman, fluorescence, brightfield, or quantitative-phase images; and having different selectable levels of magnification from 1× to 100×;
a second objective having different levels of magnification from 1× to 100× for guiding an Airy beam, Bessel beam, optical lattice, or gaussian beam generated by a first spatial light modulator (SLM) for illuminating a sample with an illumination beam, the sample receiver comprising a material or materials having a refractive index or indices substantially matching the refractive index of a sample or sample medium, wherein the first and second objectives are configured so that illumination and detection are arranged orthogonally;
a condenser to guide white illumination to the sample;
a light conduit arranged parallel to the detection objective;
a filter to direct Raman or fluorescence signal to a single-photon or photon-sparse camera and transmitted white light to the same or second camera;
a device for viewing, generating and/or capturing an image or images produced by the system.

23. An imaging system, comprising:
a single objective to collect Raman, fluorescence, brightfield, or quantitative-phase images and also for guiding an Airy beam, Bessel beam, optical lattice, or gaussian beam; and having different selectable levels of magnification from 1× to 100×;
a condenser to guide white illumination to the sample;
a filter to direct Raman or fluorescence signal to a single-photon or photon-sparse camera and transmitted white light to the same or second camera;
a device for viewing, generating and/or capturing an image or images produced by the system; and
a computer vision or deep learning algorithm to reconstruct the single-photon or photon-sparse images.

24. A method, comprising:
providing an imaging system according to claim 1; and using the system.

25. The method according to claim 24, using the system for imaging a biological system.

26. The method according to claim 25, comprising imaging a cell, imaging an organelle, imaging an organ, or imaging an organism.

27. The method according to claim 26 comprising imaging a live cell sample.

28. The method according to claim 27 wherein bright-field or quantitative-phase imaging provides label-free information concerning location, size and dry-density of cells and organelles and Raman or fluorescence provides information concerning intracellular dynamics of specific molecular species.

29. The method according to claim 28 comprising imaging a single cell.

30. The method according to claim 22, comprising imaging a chemical reaction medium or constituents thereof.
